(19) United States
(12) Patent Application Publication
(10) Pub. No.: US 2007/0023447 A1
(43) Pub. Date: Feb. 1, 2007

(54) Discharger for tablets

(76) Inventor: Jeong Min Yoon, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/190,286

(22) Filed: Jul. 26, 2005

(51) Int. Cl. G07F 11/16

(52) U.S. Cl. 221/232

(57) ABSTRACT

Disclosed is a discharger for contents in tablet form. The discharger comprises: a first main body and a second main body each having a side wall, a rear surface, a top surface, a bottom surface and an inner wall surface, and arranged in the left and right; a discharge means located between the first main body and the second main body; and a cover member for finishing the front parts of the first and second main bodies coupled to each other. Especially, the discharge means to be inserted between the first main body and the second main body vertically and reciprocally moves within the dimensions of an opening formed on the rear surface of the discharger, thereby carrying out stored contents to an outlet of the cover member. A storage chamber is formed in the front side of the inner wall surface as the first main body and the second main body are fitted to each other, and the storage chamber is a space for stacking contents therein and has a spring for always pressurizing the contents toward the top surface of the discharger and a mounting member formed on the top of the spring.

### BACKGROUND OF THE INVENTION

1. Field of the Invention

The present invention relates to a discharger which holds a variety of contents including candies and pills maintaining tablet or pill forms and ring or coin shaped ones, and which is arranged to easily carry out them when necessary.

2. Description of the Related Art

In reality, most people use containers of various shapes which is capable of easily storing and carrying specific contents, carrying out them whenever necessary, and refilling contents. Especially, patients who must take pills in tablet or pill form regularly all the time commonly used to store pills in a sealed storage container made of plastic or steel for use. The pills to be held in such a sealed storage container are effective in seeking the convenience of storage and refilling and preventing the pills from contact with the external environment, while if the storage container is shaken unnecessarily, the pills are broken and crushed into powder in granule form because the pills are not fixedly arranged in a given manner, thereby causing inconvenience when taking the pills.

In contrast, there have been a considerable number of containers applying a spring force so as to make it easy to carry coins or scrip money, for example, tokens or the like and easily carry out them. As shown in FIG. 7, a conventional coin storage box 100 typically comprises a cylindrical main body 110, a coin mounting plate 120 formed in the main body 110, and a spring 130 fixed at the bottom of the coin mounting plate 120 for providing an elastic force. Especially, the coin storage box 100 according to the conventional art is provided with an opening 140 opened to the top thereof for helping to insert and take out coins. The opening 140 only opens one side of the top of the main body of the con storage box 100. When a coin is inserted into the opening 140 formed on the top of the coin storage box 100, the coin is mounted on the coin mounting plate 120. Simultaneously, the spring 130 arranged below the coin mounting plate 120 is pressurized to have the coin stored hung under the top of the coin storage box 100.

However, the coin storage box 100 according to the conventional art has a problem in that if a force capable of sufficiently carrying out coins stored therein is unnecessarily applied through the opening 140, the coins are partially exposed to outside all the time as well as the coins can be discharged. Particularly, in case of holding chemicals or foods with a smaller rigidity excluding coins, there always exists a risk of contamination and damage because the contents are always in contact with outside.

### SUMMARY OF THE INVENTION

Accordingly, it is an object of the present invention to provide a discharger for tablets, which can discharge contents out of the container by a simple manual operation, that is, the operation of merely upwardly pushing a push button of a discharge means protruded through an opening formed on the rear surface of the discharger, while restricting contact with the outside.

Schematically, the discharger according to the present invention comprises: a first main body and a second main body arranged in the left and right, each having side wall surfaces, a rear surface, a top surface, a bottom surface, and an inner wall surface extending therein in a longitudinal direction; a discharge means located between the first main body and the second main body; and a cover member for finishing the front parts of the first main body and second main body bound to each other. Especially, the discharge means to be inserted between the first main body and the second main body vertically and reciprocally moves within the dimensions of the opening formed on the rear surface of the discharger, thereby carrying out stored contents to a outlet of the cover member. A storage chamber is formed in the front side of the inner wall surface as the first main body and the second main body are fitted to each other, and the storage chamber is a space for stacking contents therein and has a spring for always pressurizing the contents toward the top surface of the discharger and a mounting member formed on the top of the spring.

### BRIEF DESCRIPTION OF THE DRAWINGS

The above aspects and features of the present invention will be more apparent by describing certain embodiments of the present invention with reference to the accompanying drawings, in which:

FIG. 1a is a perspective view of a discharger according to the present invention when viewed from the front;

FIG. 1b is a perspective view of the discharger according to the present invention when viewed from the rear;

FIG. 2 is a use state diagram of the discharger according to the present invention;

FIG. 3 is a bottom view of the discharger according to the present invention;

FIG. 4 is an exploded perspective view of the discharger according to the present invention;

FIG. 5 is a partial cut-away view of the discharger according to the present invention;

FIG. 6 is a view showing a discharger according to another embodiment of the present invention; and

FIG. 7 is a cross sectional view of a coin storage box according to the conventional art.

### DETAILED DESCRIPTION OF THE PREFERRED EMBODIMENTS

A discharger according to the present invention will now be described in more detail with reference to the accompanying drawings.

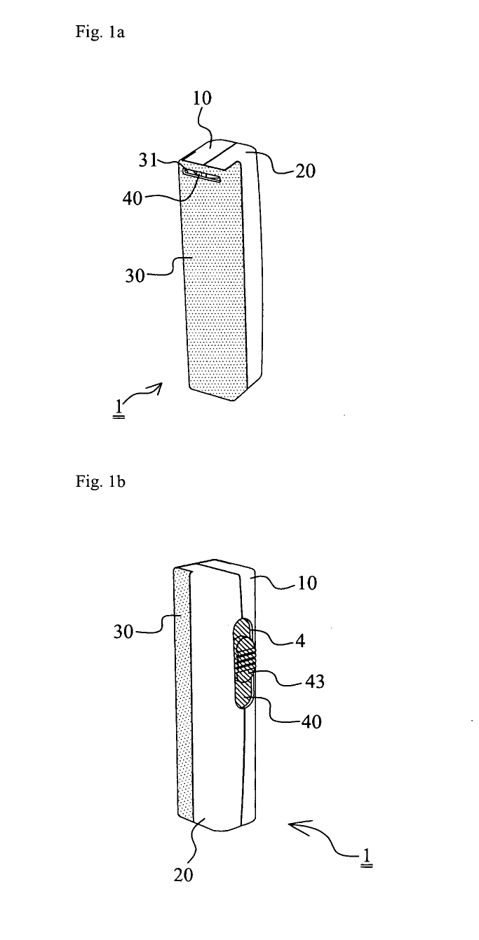

FIG. 1a is a perspective view of a discharger according to the present invention when viewed from the front. FIG. 1b is a perspective view of the discharger according to the present invention when viewed from the rear.

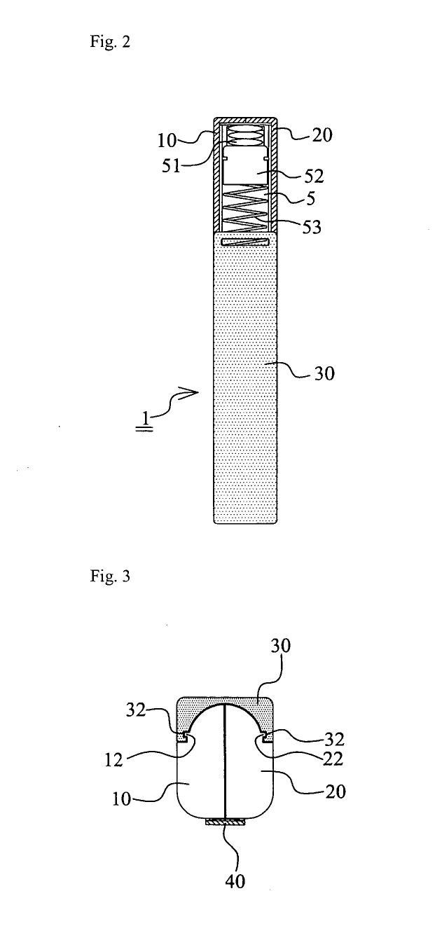

As illustrated therein, the discharger 1 of this invention comprises a first main body 10, a second main body 20, a cover member 30 and a discharge means 40. During an assembling process, the discharge means 40 is located between the first main body 10 and the second main body 20 and thereafter the first and second main bodies 10 and 20 are fitted to each other. Then, the front parts of the first main body 10 and the second main body 20 where the cover member 30 is assembled are sealed. Moreover, as the first main body 10 and the second main body 20 are coupled to each other, a storage chamber 5 (refer to FIG. 2) is formed therein.

In particular, the cover member 30 is vertically movable in a longitudinal direction so that it may be opened or sealed within a given limit range in order to stack (or refill) contents in the storage chamber formed from the first main body 10 and the second main body 20, while the cover member 30 may be completely pulled out of the main bodies in a coupled state.

In the discharger 1 according to the present invention, contents of various forms including tablet or pill forms and ring or coin forms are stacked in the storage chamber, and when necessary, the contents can be carried out through a outlet 31 by a manual operation of merely pushing the discharge means 40 upward. In the discharger 1 of this invention, a push button 43 of the discharge means 40 is protruded through the opening 4. The front part of the discharge means 40 reaches near to the outlet 31 of the cover member 30 or is spaced away from it by changing the position of the push button 43. By repeating such a procedure, the contents can be carried out to outside one by one.

FIG. 2 is a use state diagram of the discharger according to the present invention. While FIG. 1a illustrates a state in which multliple stacked contents can be discharged when necessary, with the cover member 30 of the discharger 1 completely sealing the storage chamber, FIG. 2 illustrates a state in which the cover member 30 is opened within a given range so as to load contents in the storage chamber 5 as stated above.

The discharger 1 according to the present invention, multiple contents in tablet form are stacked in the storage chamber 5 formed by coupling the first main body 10 and the second main body 20. The inside of the storage chamber 5 is equipped with a spring 53, a mounting member 52, and multiple contents 51 to be loaded on the mounting plate 52. The discharger 1 undergoes the following procedure in order to stack the contents 51 therein. First, the cover member 30 covering the front part of the discharger 1 is opened downward. Next, a user loads the contents 51 one by one on the mounting member 52 provided on the top of the spring 52. As the contents 51 are mounted on the mounting member 52, they pressurizes the spring 52 having a predetermined elasticity. When the contents are released, the spring 52 having such an elasticity presses the remaining contents by a shape restorability toward the discharger 1, more concretely, toward the top of the storage chamber 5 in order to continuously restrict the movement of the contents 51 in the storage chamber 5.

FIG. 3 is a bottom view of the discharger according to the present invention.

Referring to this drawing, in the discharger of this invention, the cover member 30 is located on the front parts of the first main body 10 and the second main body 20 coupled to each other. Slots 32 are provided on inner sides of both lateral sides of the cover member, corresponding to sliding portions 12 and 22, such that the cover member 30 may be moved along the respective sliding portions 12 and 22 longitudinally formed on the edges of both side wall surfaces of the first main body 10 and the second main body 20. More concretely, after the two main bodies 10 and 20 are arranged side by side, the slots 32 of the cover member 30 are located by being fitted to the underside of the respective sliding portions 12 and 22 formed in a longitudinal direction of the coupled main bodies 10 and 20, and the storage chamber of the discharger according to the present invention is sealed by pushing up the cover member 30. Since the cover member 30 surrounds the front parts of the coupled main bodies 10 and 20, the coupled state of the discharger according to the present invention becomes firmer.

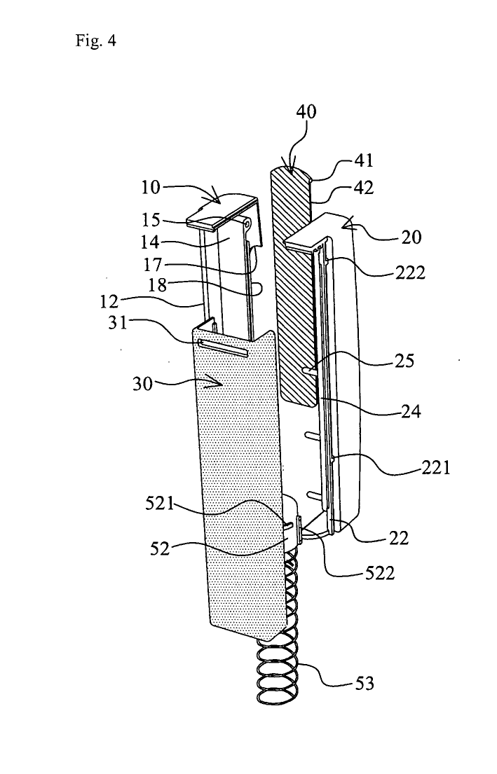

FIG. 4 is an exploded perspective view of the discharger according to the present invention. Component members may not be shown partially because they are overlapped with one another. Especially, each of the members constituting the first main body and the second main body have a corresponding shape, thus they may not be illustrated concretely.

The discharge means 40 is located between the first main body 10 and the second main body 20, and has a front end portion 41, a thin longitudinal portion 42 and a push button 43 (refer to FIG. 1b). Preferably, the longitudinal portion 42 is made of a material having a flexibility, for instance, a plastic material. Optionally, the thickness of the front end portion 41 of the discharge unit 40 is greater than the overall thickness of the longitudinal portion 42, thus easily pushing one of the contents on the highest end stacked on the mounting member 52.

The first main body 10 has a couple of side walls, a rear surface, a top surface, a bottom surface, and an inner wall surface 14 defining the storage chamber 5 (refer to FIG. 2). The second main body 20 has a couple of side walls, a rear surface, a top surface, a bottom surface, and an inner wall surface 24 defining the storage chamber so as to correspond to the first main body 10 from a structural viewpoint. Further, respective sliding portions 12 and 22 are longitudinally provided on the edges of the side walls of the first and second main bodies 10 and 20. More preferably, the inner wall surfaces 14 and 24 are spaced at a predetermined gap from the top surfaces of the main bodies 10 and 20. This spacing gap is used as a passage for passing the longitudinal portion 42 of the discharge means 40 therethrough.

To assemble the first main body 10 and the second main body 20, the first main body 10 is provided a plurality of fastening holes 15 on the back of the inner wall surface 14, and the second main body 20 is provided with a plurality of fastening projections 25 on the back of the inner wall surface 24. The plurality of fastening holes 15 are arranged at the same interval with the fastening projections 25 fastened thereto, thereby helping the fastening of the first main body 10 and the second main body 20 initially separated from each other. As is widely known to those skilled in the art, a variety of fastening means, such as an adhesive, may be additionally employed to assemble the first main body and the second main body.

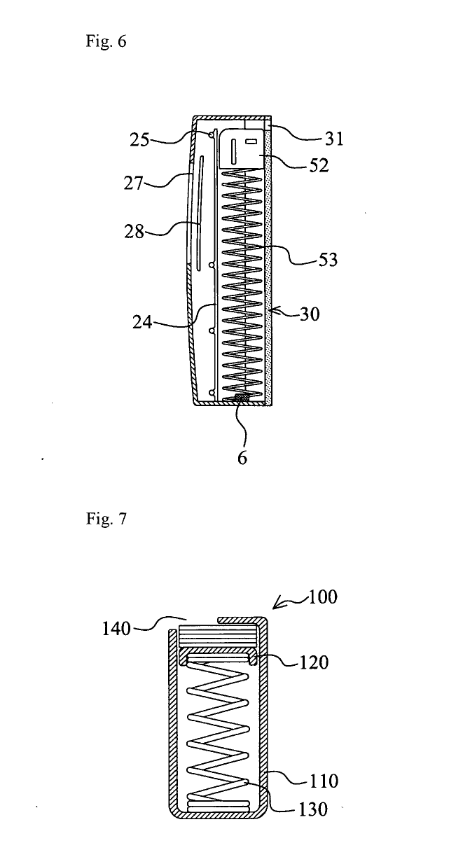

As described above, before the first main body 10 and the second main body 20 are coupled, the discharge means 40 has to be located between the main bodies to be coupled. Preferably, supports 18 and 28 (refer to FIG. 6 for the support 28) are additionally provided on the back of the inner wall surfaces 14 and 24 in order to arrange the discharge means 40 at a proper position and move it along a given path. The supports are provided between the inner wall surfaces 14 and 24 and the rear surface formed on the respective main bodies. More preferably, the supports are located in parallel between the opening 4 (refer to FIG. 1b), which is formed by aligning two concave recesses 17 and 27 (refer to FIG. 6 for the concave recess 27) formed on the rear surfaces of the respective main bodies 10 and 20, and the inner wall surfaces 14 and 24. The push button of the discharge means 40 is projected through the opening, and the longitudinal portion 42 having flexibility of the discharge means 40 is arranged on the supports. Especially, the front end portion 41 of the discharge means 40 is hung on the highest ends of the inner wall surfaces 14 and 24, and thereafter the front end portion 41 goes forward or backward to the outlet 31 of the cover member 30 according to a change in the height of the longitudinal portion of soft material of the discharge means 40.

After the storage chamber is formed by coupling the main bodies 10 and 20, the spring 53 of a thin and long spiral shape is located in the storage chamber. Next, the mounting member 52 is placed on the upper end of the spring 53. This mounting member 52 varies in height in the storage chamber according to a quantity of contents pressing the spring 53. Especially, it is preferable that a plurality of projections are additionally provided around the outer surface of the mounting member 52 so that mounting member 52 only moves along a given path without deviating from the hollow space of the storage chamber. Two first projections 521 and two second projections 522 surrounding the respective sliding portions are provided symmetrically on the circumferential surface of the mounting member 52 so that the mounting member 52 move vertically along the back of both sliding portions 12 and 22 formed on the edges of the side walls of the respective main bodies 10 and 20. In other words, the back sides of the sliding portions 12 and 22 are held between the first projections 521 and the second projections 522. Further, it is helpful for sliding that the spacing between the first projections 521 and the second projections 522 has at least the same or greater thickness than the sliding portions. Additionally, the mounting member 52 can prevent the sliding portions from being pulled out in directions other than the formation direction of the sliding portions.

Moreover, the cover member 30 is mounted on the front part of the discharger 1 so as to make the coupled state of the first main body 10 and the second main body 20 firmer while sealing the opened front part of the storage chamber. As shown in FIG. 3, the cover member 30 is provided with two slots engaging the sliding portions 12 and 22 extending in a longitudinal direction on the side walls of the respective main bodies. Unless the discharger will not be dissembled for the purpose of complete dissembling, first ridges 121 and 221 (the first ridge 121 of the first main body is not shown) are provided on the lower ends of the two sliding portion 12 and 22 so that the cover member 30 may not be released from the discharger according to the present invention, and second ridges 122 and 222 (the second ridge 122 of the first main body is not shown) are provided on the upper ends of the sliding portions 12 and 22 in order to help to fix the cover member 30 when the cover member 30 fully covers the storage chamber. Additionally, there are provided with first and second recesses corresponding to the first ridges 121 and 221 and the second ridges 122 and 222 restricting unnecessary movement when the cover member 30 smoothly slides along the longitudinal direction of the sliding portions 12 and 22.

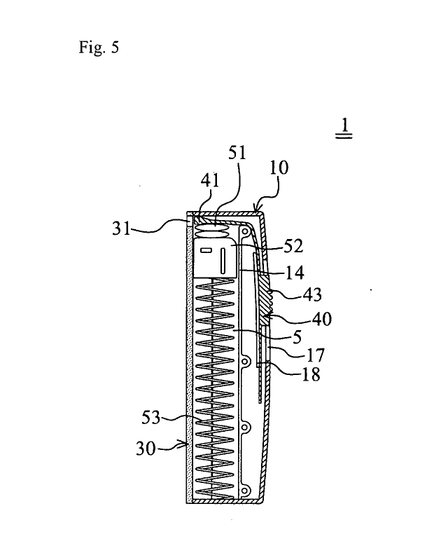

FIG. 5 is a partial cut-away view of the discharger according to the present invention, in which the selection of the position of the discharge means 40 is illustrated.

In operation, multiple contents 51 are stacked in the discharger 1 of this invention, more concretely, inside the storage chamber 5. Such contents 51 are released to the outlet 31 formed on the top of the cover member 30. The contents correspond to the size and shape of the outlet 31. Preferably, the contents are in tablet form.

Once the discharge means 40 is raised upward, the contents 51 are carried out through the outlet 31 one by one. The first main body 10 has a concave recess 17 on the edge of the rear surface. Correspondingly, although not shown, the second main body has a concave recess 27 on the edge of the rear surface. The concave recesses provided respectively on both of the main bodies are faced to each other to thus form an opening 4 (as shown in FIG. 1b) of the discharger. FIG. 5 does not particularly show the second main body since this figure is a partially cut-away view. The push button 43 fitted to the opening performs reciprocal vertical movement within the opening. In other words, in order for the user to take the contents 51 stacked in the discharger, the user has to push the push button upward. Especially, when a considerable external force is applied to the push button 43 so as to help vertical reciprocal movement of the discharge means 40, the first main body 10 additionally locates a support 18 in parallel between the concave recess 17 and the inner wall surface 14. By this, even if an external force required to carry out contents is applied to the push button 43, the discharge means 40 is not pulled out of a guide passage.

After the discharge means 40 is raised upwardly of the opening in order to carry out contents, the discharge means 40 is moved downwardly of the opening in order to extract the next contents. That is to say, the front end portion 41 of the discharge means 40 adjacent to the outlet 31 is wholly pulled back from the outlet through the downward movement of the push button 43. When the front end portion 41 is pulled back, the mounting member 52 rises as high as the height of the released contents via the spring 53, and the highest part of the storage chamber is refilled. Next, as the user pressurizes the push button 43 upward, the contents located on the highest part of the storage chamber are extracted to outside.

FIG. 6 is a view showing a discharger according to another embodiment of the present invention.

A storage chamber 5, which is formed from some parts of side walls of respective main bodies and two inner wall surfaces extending in a longitudinal direction between the top surface and the bottom surface by coupling the first main body and the second main body, is provided with a spring 53 and a mounting member 52, and is sealed with a cover member 30. Especially, a fixture 5 may be additionally provided on the bottom surface of the storage chamber so that the spring 53 may not be moved in the storage chamber 5 in the left and right directions but stood in the lengthwise direction of the storage chamber.

As shown therein, FIG. 6 is a partial cut-away cross sectional view of the discharger according to the present invention, excluding the first main body. Particularly, the second main body correspondingly combined with the first main body as shown in FIG. 5 is shown in FIG. 6. The discharger is provided with an inner wall surface 24 longitudinally extending between the top surface and the bottom surface. This inner wall surface 24 has a spacing from the top surface, and a concave recess 27 constituting the opening of the discharger is provided on the rear surface of the second main body 20. Further, fastening projections 25 corresponding to fastening holes 15 and for helping coupling with the first main body are located on the back of the inner wall surface 24. Moreover, a support 28 is arranged in parallel between the concave recess 27 of the rear surface and the inner wall surface 24.

It should be understood that the present invention is not limited to the accompanying drawings and above-described embodiments, but it may variously be modified and changed within the scope of the present invention.

As described above, according to the present invention, multiple contents stacked in the discharger according to the present invention, concretely, in the storage chamber are carried out to the outlet by a user's simple operation of upwardly pushing the push button when necessary.

In particular, since contents in tablet form are stored in the discharger of this invention, the contents can be maintained and preserved in a clean condition because they can avoid contact with the outside to the utmost extent. Besides, the contents are not shaken, being pressed by a spring force in a given internal space, thus there is no risk that they are broken into powder or damaged. Further, the cover member opens the front part of the discharger so as to easily refill contents in the storage chamber.

What is claimed is:

1. A discharger for tablets, comprising:
a first main body having side walls, a rear surface, a top surface, a bottom surface, which is provided with a sliding portion extending on the edge of the side walls along a longitudinal direction an inner wall surface, a concave recess formed on the rear surface and an inner wall surface extending inside the side wall along a longitudinal direction and having a spacing from the top surface;
a second main body having side walls, a rear surface, a top surface, a bottom surface so as to correspond in shape to the first main body, which is provided with a sliding portion extending on the edge of the side walls along a longitudinal direction an inner wall surface, a concave recess formed on the rear surface and an inner wall surface extending inside the side wall along a longitudinal direction and having a spacing from the top surface, thereby joining to the first main body;
a cover member which is provided with slots for vertical reciprocal movement in engagement with the sliding portions formed on the respective main bodies and an outlet for carrying out contents in tablet form;
a discharge means which is arranged between the inner wall surfaces and rear surfaces of the first and second main bodies and is provided with a thin longitudinal portion and a push button arranged on an opening; and
a spring which provides an elastic force and continuously pushes the contents upward;
wherein the contents are discharged by using discharge means.

2. The discharger as claimed in claim 1, wherein a mounting member is additionally provided on the top of the spring.

3. The discharger as claimed in claim 2, wherein the mounting member is provided with a couple of first and second projections on the outer circumferential surface thereof.

4. The discharger as claimed in claim 1, wherein the cover member is additionally provided with at least one ridge on the slots for restricting the movement of the cover member on the sliding portions of the first main body and second main body coupled to each other.

5. The discharger as claimed in claim 1, at least two supports are provided between the inner wall surfaces provided on the main bodies and the opening for supporting and holding the discharge means.

6. The discharger as claimed in claim 1, wherein a fixture is additionally provided on the bottom of a storage chamber, preferably, the height of the fixture is smaller than the height of the mounting member.

7. The discharger as claimed in claim 1, wherein a front end portion has a greater thickness than the longitudinal portion.

8. The discharger as claimed in claim 1, wherein the first and second main bodies are joined by fastening holes and fastening projections.

9. The discharger as claimed in claim 1, wherein the contents are in tablet from or ring form.
